(19) United States
(12) Patent Application Publication
(10) Pub. No.: US 2026/0194023 A1
(43) Pub. Date: Jul. 9, 2026

(54) CONTROL METHOD AND CONTROL DEVICE FOR A HYBRID TURBINE ENGINE

(71) Applicant: SAFRAN AIRCRAFT ENGINES, Paris (FR)

(72) Inventors: Seif Eddine BENATTIA, MOISSY-CRAMAYEL (FR); Rudy Charles André AULNETTE, MOISSY-CRAMAYEL (FR); Christophe LABBE, MOISSY-CRAMAYEL (FR)

(73) Assignee: SAFRAN AIRCRAFT ENGINES, Paris (FR)

(21) Appl. No.: 19/133,860

(22) PCT Filed: Nov. 27, 2023
(86) PCT No.: PCT/FR2023/051856

§ 371 Date: Jul. 3, 2025

(30) Foreign Application Priority Data
Nov. 30, 2022 (FR) FR 2212564

(51) Int. Cl. F02C 9/48; F01D 15/10

(52) U.S. Cl. CPC F02C 9/48; F01D 15/10; F05D 2220/323; F05D 2270/304; F05D 2270/335

(57) ABSTRACT

A method for controlling a hybrid turbine engine includes determining a sequence of deviations, each being a difference between one measurement of a sequence of measurements of a speed of a drive shaft of the engine and one setpoint of a sequence of engine speed setpoints, determining a variation of a fuel flow rate and determining a variation of an electrical torque, the determining the variation of fuel flow rate and the determining the variation of electrical torque both use a difference between a last measurement and a penultimate measurement of the sequence of measurements, a last deviation of the sequence of deviations that is temporally associated with the last measurement, and a sum of the deviations of the sequence of deviations, and controlling the hybrid turbine engine in order to vary the fuel flow rate and the electrical torque according to the determined variations.

### FIELD OF THE INVENTION

The invention relates to the control of a hybrid turbine engine, i.e. a turbine engine having a thermal drive and an electrical drive.

The invention relates, in particular, to a control method and a multivariable control device, i.e. one taking into account several degrees of freedom of the controlled system.

### PRIOR ART

A hybrid turbine engine has two degrees of freedom, namely a flow rate of fuel sent into the combustion chamber and an electrical torque applied to a drive shaft of the turbine engine. Consequently a hybrid turbine engine is considered to a be a multivariable system.

The flow rate of fuel sent into the combustion chamber and the electrical torque applied to a drive shaft of the turbine engine are the “inputs” of the turbine engine system. Each acts on the engine speed, i.e. an angular speed of the drive shaft which is an “output” of the turbomachine system.

The two inputs of the system, which are the flow rate of fuel sent into the combustion chamber and the electrical torque applied to the drive shaft of the turbine engine, must be regulated: their value must be determined automatically and in real time to ensure good operation of the turbine engine, i.e. to obtain satisfactory output quantity values.

Good operation of the turbine engine can, in particular, be characterized by good tracking of a setpoint curve by the output quantity of the turbine engine.

A setpoint curve of an output quantity, the engine speed for example, is a continuous curve or a temporal sequence of setpoint values representing the desired temporal evolution of such an output quantity, thus here the speed of the drive shaft. The closer the real engine speed is to this setpoint curve, the better is the operation of the turbine engine.

A control method of the turbine engine is a regulation of the input quantities of the turbine engine system based on at least one output quantity of the turbine engine system. For this purpose, it is necessary to have available not only a setpoint curve of the output quantity, but also a real-time measurement of the output quantity.

The control methods of a hybrid turbine engine described previously are not satisfactory because they can require an additional output quantity, such as for example the enrichment. This assumes that not only a setpoint curve, but also that a real-time measurement of this additional quantity is available. Yet these two elements can be very difficult to determine or to implement, particularly the enrichment.

The control methods of a hybrid turbine engine previously described are also not satisfactory, because they can regulate one input quantity as a function of the other, for example the determination of the electrical torque can occur after and as a function of the determination of the fuel flow rate. In particular, the electrical torque can be held at a zero value as long as the fuel flow rate can be increased. The two degrees of freedom of the turbine engine are then not used in an independent and optimal manner.

There exists therefore a need for a control method for a hybrid turbine engine which allows independently using the two degrees of freedom without resorting to output quantities, the setpoint curve or the measurement in real time of which is difficult to determine or to implement.

### DISCLOSURE OF THE INVENTION

One object of the invention is to propose a control method for a hybrid turbomachine allowing independently using two degrees of freedom without resorting to output quantities for which a setpoint curve or a measurement in real time is difficult to determine or to implement.

The object is attained within the scope of the invention due to a method for controling a hybrid turbine engine comprising the following steps:
determining a sequence of deviations, each deviation being a difference between
   one measurement of a sequence of measurements of a speed of a drive shaft of the hybrid turbine engine and
   one set point of a sequence of setpoints of the engine speed,
determining a variation of fuel flow rate and determining a variation of electrical torque, the determinations in particular being simultaneous, and each of the determinations using
   a difference between a last measurement of the sequence of measurements and a penultimate measurement of the sequence of measurement, a last deviation associated with the last measurement, and
   a sum of the variations of the sequence of variations; and
      controlling the hybrid turbine engine in order to vary a fuel flow rate of the determined variation of fuel flow rates and an electrical torque of the determined variation of electrical torque.

A method of this type is advantageously and optionally completed by the following different features, taken alone or in combination:
during the determination of the variation of fuel flow rate and of the variation of electrical torque, a product of a gain matrix and a vector is determined, the vector being formed from the difference between the last measurement and the penultimate measurement, of the last deviation and of the sum of the deviations;
the gain matrix is obtained by interpolation between two reference matrices of a set of reference matrices so as to take into account a operating point of the hybrid turbine engine associated with the last measurement;
The invention also applies to a control device for a hybrid turbine engine comprising:
an input, configured to receive a sequence of measurements of the engine speed of the hybrid turbine engine,
a memory, configured to record the sequence of measurements and a sequence of speed setpoints,
a computer, configured to:
   determine a sequence of deviations, each deviation being a difference between
      one measurement of a sequence of measurements of the engine speed of the hybrid turbine engine, and
      one setpoint of a sequence of engine speed setpoints,
   determining, in particular simultaneously, a variation of fuel flow rate and a variation of electrical torque, each of the determinations using
      a difference between a last measurement of the sequence of measurements and a penultimate measurement of the sequence of measurements,
      a last deviation associated with the last measurement, and
      a sum of the deviations of the sequence of deviations; and
an output configured to provide a command to the hybrid turbine engine.

The invention also relates to a turbine engine comprising a control device as described previously and an aircraft comprising a turbine engine of this type.

### DESCRIPTION OF THE FIGURES

Other features and advantages of the invention will still be revealed by the description that follows, which is purely illustrative and not limiting, and must be read with reference to the appended drawings in which:

FIG. 1 is a schematic representation of a control device according to one embodiment of the invention;

FIG. 2 is a schematic representation of acceleration control tracking according to one embodiment of the invention; and

FIG. 3 is a schematic representation of deceleration control tracking according to one embodiment of the invention.

### DETAILED DESCRIPTION OF THE INVENTION

### Hybrid Turbine Engine

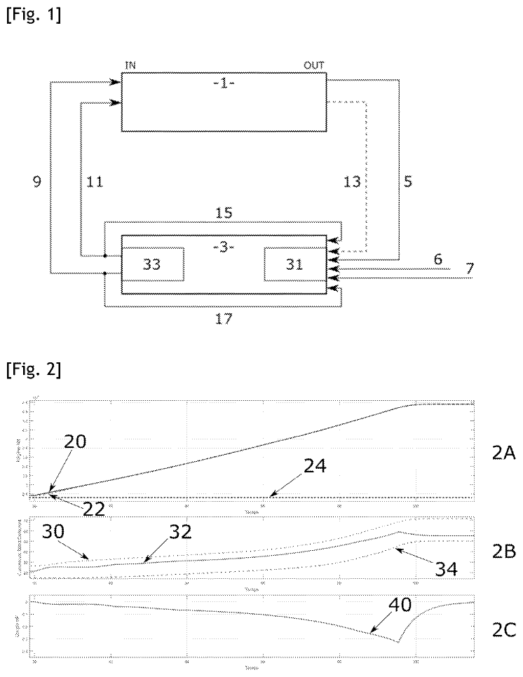

FIG. 1 is a schematic representation of a control device according to one embodiment of the invention, in which a hybrid turbine engine 1 comprises two drives for a high-pressure and/or low-pressure drive shaft set in motion by a thermal drive and an electrical drive.

The hybrid turbine engine can be considered, from a control point of view, as a multivariable system comprising two control or input quantities:
a fuel flow rate command “WF,” labeled 9 in FIG. 1, sent to a local loop of a metering valve of the hybrid turbine engine 1,
an electrical torque command “TRQ,” labeled 11 in FIG. 1, to be applied by an electrical machine to the high-pressure and/or low-pressure drive shaft.

More generally, the hybrid turbine engine 1 has several output quantities which must be regulated and/or limited, such as in particular a speed of the low-pressure drive shaft, a speed of the high-pressure drive shaft, possibly a combustion chamber inlet pressure.

Moreover, the turbine engine must be of the twin spool, double flow type, so that it comprises a low-pressure shaft and a high-pressure shaft. In such a case, the controlled electrical torque mentioned above is an electrical torque applied to the high-pressure shaft. An electrical torque can also be applied to the low-pressure shaft, but within the scope of this text this torque is then the object of an indirect control constructed based on the control of the electrical torque applied to the high-pressure shaft.

### Control Device

A control device 3 able to control the hybrid turbine engine 1 is shown in FIG. 1.

The operation of the hybrid turbine engine 1 is regulated by using input quantities, shown in FIG. 1, arriving in the hybrid turbine engine 1, on the “IN” side, and one output quantity, shown in FIG. 1, leaving the hybrid turbine engine 1, on the “OUT” side.

The input quantities used are a fuel flow rate and an electrical torque. More precisely, the control device 3 provides the command 9 for the fuel flow rate to be sent into the combustion chamber and the electrical torque command 11 to be applied to a drive shaft of the hybrid turbine engine 1. The output quantity used in the engine speed. This can be the speed of a high-pressure or low-pressure drive shaft. One measurement of the engine speed 5 is sent to the control device 3. Measurement of the engine speed 5 assumes, in the hybrid turbine engine 1, that a sensor of the engine speed is available in the hybrid turbine engine 1.

The control device 3 can also receive an engine speed setpoint 7.

A setpoint is a continuous curve or a temporal sequence of values representing a desired temporal evolution of the engine speed, namely an angular speed of the drive shaft. In particular, the setpoint can be associated with a particular maneuver such as a takeoff, a landing, etc. . . .

The control device 3 can also receive a measurement of the external pressure 6. Based on the received measurement of the engine speed 5 and the measurement of the external pressure 6, the control device 3 can construct an indicator, for example a transient detection indicator signaling an operating speed where the parameters of the engine vary significantly (takeoff, maneuver, crossing air holes, landing, etc. . . . ), a fuel flow rate limitation indicator or fuel saturation indicator signaling that the flow rate can no longer be increased or even an electrical torque limitation indicator or electrical saturation indicator signaling that the electrical torque can no longer be increased.

The control device 3 can also be looped. To this end, the control device 3 can receive, as input,
the fuel flow rate command 9, through a fuel feedback line 17, and/or
the electrical torque command, through an electrical torque feedback line 15.

This means that the control device 3 operates by incrementation in that the fuel flow rate command 9 and the electrical torque command 11 determined at a step k use the fuel flow rate command 9 and the electrical torque command 11 determined at a step k−1, temporally preceding the step k.

Feeding back the fuel flow rate command 9, as indicated by the fuel feedback line 17, and the electrical torque command 11, as indicated by the electrical torque feedback line 15, to the control device 3, i.e. the fuel flow rate and electrical torque commands determined at step k−1, allows taking into account a possible deviation between the initial command and saturation.

The control device 3 can comprise, for example, a memory 31 configured to record:
a sequence of engine speed setpoints 7, particularly the temporal evolution of the angular speed of the drive shaft of the hybrid turbine engine 1, and/or
a sequence of measurements of the engine speed 5, particularly the temporal evolution of the speed of the hybrid turbine engine 1 received,

Moreover, the memory 31 can also record indicators 13, and/or results previously determined in the control device 3, for example at the preceding step k−1. What is understood by the terms “sequence of setpoints” or “sequence of measurements” is a temporal series of successive values of setpoints or of measurements. Each value is time stamped and/or associated with a temporal instant, so that a sequence of setpoints or of measurements corresponds to a temporal evolution of a quantity capable of being represented graphically. The control device 3 can also comprise a computer 33 configured to determine, particularly in real time, the fuel flow rate command 9 and the electrical torque command 11, for example based on data received, such as for example the measurement of the engine speed 5, the measurement of the external pressure 6 and/or the engine speed setpoint 7, and/or recorded, such as for example the sequence of setpoints of the engine speed 7, the sequence of measurements of the engine speed 5 and/or the indicators 13.

The control device 3 shown in FIG. 1 can correspond to an architecture of the “Multiple Input Single Output” type, also designated by the acronym “MISO,” because it supplies two inputs to the hybrid turbine engine 1 as a function of a single output from it.

### Control Method

The control device 3 shown allows implementing a control method of the hybrid turbine engine 1 comprising the following steps.

In a first step, a sequence of engine speed setpoints 7, particular an angular speed of a drive shaft of the hybrid turbine engine 1, is recorded. The recording of the first step occurs for example in the memory 31 of the control device 3. The recording of the sequence of engine speed setpoints 7 can have occurred prior to a start-up of the hybrid turbine engine 1 and/or before any measurement of the engine speed 5 on the hybrid turbomachine 1.

The sequence of engine speed setpoints 7 can be written in the form of values NHCₚ, where p is an index varying from 0 to N and represents a position of the value within the sequence.

In a second step, a sequence of measurements of the engine speed 5 is recorded. Once the hybrid turbine engine 1 is started, the engine speed is monitored and successive measurements are transmitted to the control device 3, forming a sequence of measurements of the engine speed 5, comprising more and more measurements over the course of time. The recording of the second step occurs for example in the memory 31 of the control device 3.

The sequence of measurements of the engine speed 5 can be written in the form of values NHₚ, where p is an index varying from 0 to k and represents a position of the value within the sequence. The index k is the index of the last measurement NHₖ received.

The indices correspond to time steps or to successive operating points of the hybrid turbine engine 1.

In a third step, the computer 33 determines a sequence of deviations between the measurement of the engine speed 5 and the engine speed setpoint 7, each deviation being equal to a difference between a measurement of the engine speed 5 and an engine speed setpoint 7 associated with the measurement. The sequence of measurements of the engine speed 5 and the sequence of engine speed setpoints 7 do not necessarily contain the same number of values, but they are temporally referenced relative to one another. In other words, with each measurement of the engine speed 5 is associated an engine speed setpoint 7, the measurement of the engine speed 5 and the setpoint being temporally coincident. The object of the regulation is to make each measurement of the engine speed 5 as close as possible to its engine speed setpoint 7.

The sequence of deviations can be written in the form of values ENHₚ, where p is an index varying from 0 to k, the deviations are calculated by index according to the calculation:

$${ENH}_{p} = {NH}_{p} - {NHC}_{p} .$$

In a fourth step, the computer 33 determines, in particular simultaneously, a variation of fuel flow rate ΔWFₚ, corresponding to a difference in the fuel flow rate command 9 between an instant p and a preceding incident p−1, or:

$$Δ {WF}_{p} = {WF}_{p} - {WF}_{p - 1}$$

and a variation of electrical torque ΔTRQₚ, corresponding to a difference in the electrical torque command 11 between an instant p and a preceding instant p−1, or:

$$Δ {TRQ}_{p} = {TRQ}_{p} - {TRQ}_{p - 1} .$$

The fuel flow rate command 9 and the electrical torque command 11 are signals that vary over time and that can be discretized in the form of a temporal sequence of fuel flow rate command WFₚ and an electrical torque command sequence TRQₚ.

The values of the temporal fuel flow rate command sequence W Fₚ and of the electrical torque command sequence TRQₚ are indexed by an index p varying from 0 to k, each command being associated with the same measurement.

The variation of fuel flow rate command ΔWFₚ and the variation of electrical torque command ΔTRQₚ occur as a function:
of a difference of the engine speed between a last measurement and a penultimate measurement of the engine speed 5 of the hybrid turbine engine 1,
of a deviation ENHₖ associated with the last measurement of the engine speed 5, and
of a sum of all the deviations.

The last measurement of the engine speed 5 is the last measurement received by the control device 3 and therefore constitutes the most recent measurement of the state of the engine speed. Thus it is the measurement NHₖ corresponding to the last index k. The difference between the last measurement and the penultimate measurement of the engine speed 5 is written:

$$Δ {NH}_{k} = {NH}_{k} - {NH}_{k - 1} .$$

The deviation associated with the last measurement of the engine speed 5 is written:

$${ENH}_{k} = {NH}_{k} - {NHC}_{k} .$$

The sum of all the deviations IENHₖ is calculated according to the following expression:

$${IENH}_{k} = {ENH}_{0} + {ENH}_{1} + {ENH}_{2} + … + {ENH}_{k - 1} + {ENH}_{k} .$$

The sum of all the deviations IENHₖ corresponds to an integral of the error from the index p=0 to the last index p=k.

The method as presented above uses three output quantities, all constructed on the basis of the angular speed (angular speed setpoint and measurement of the angular speed): the difference between a last measurement and a penultimate measurement, the deviation associated with the last measurement, and the sum of all the deviations. These three quantities allow determining the input quantities without resorting to an output quantity other than the angular speed and in particular without resorting to an output quantity, the setpoint curve or the real-time measurement of which would be difficult to determine or to implement. Moreover, when this determination of the values of the input quantities occurs simultaneously, the two degrees of freedom of the turbine engine are used in a more optimal manner than in the prior art.

A determination of this type relies on a particular modeling of the hybrid turbine engine 1 by a Linear Time-Invariant type system, also designated by the acronym LTI, where to pass from the index k to the index k+1 the engine speed is given by a first equation, or equation (1):

$$Δ {NH}_{k + 1} = A \times Δ {NH}_{k} + B \times [ \begin{matrix}Δ {WF}_{k} \\ Δ TR {Q}_{k}\end{matrix} ] \qquad ( eq . 1 )$$

Equation (1) is a synthetic model. It constitutes a mathematical description of the system allowing connecting the inputs, namely the fuel flow rate command 9, the fuel flow rate setpoint, the electrical torque command 11, and/or the electrical torque setpoint, and the output, namely the engine speed.

The term A of equation (1) is a state matrix. The term A of equation (1) can be assimilated to a time constant, particularly characteristic of the response time linked to the inertia of the hybrid turbine engine 1.

The term B of equation (1) is a control matrix. The term B of equation (1) is able to contain information about a system gain, particularly a static gain establishing a link between a setpoint increment (fuel flow rate and/or electrical torque) and an increment of speed obtained by this setpoint increment once the speed is stabilized.

To cancel a dynamic error, also called lag, consisting of a delay between a linear variation of the setpoint and the corresponding variation of the engine speed, it is proposed to use an “augmented” synthetic model.

To this end, the “augmented” synthetic model uses, in addition to the difference ΔNHₖ between the last measurement and the penultimate measurement of the engine speed 5:
the deviation ENHₖ associated with the last measurement of the engine speed 5, corresponding in particular to a servo error, and
the sum of all the deviations IENHₖ, corresponding in particular to the integral of the servo error,

according to a second equation, or equation (2), that is more general than the first equation, or equation (1):

$$[ \begin{matrix}Δ {NH}_{k + 1} \\ {ENH}_{k + 1} \\ {IENH}_{k + 1}\end{matrix} ] = [ \begin{matrix}A & 0 & 0 \\ - 1 & 1 & 0 \\ - 1 & 1 & 1\end{matrix} ] [ \begin{matrix}Δ {NH}_{k} \\ {ENH}_{k} \\ IENH\end{matrix} ] + [ \begin{matrix}B \\ 0 \\ 0\end{matrix} ] [ \begin{matrix}Δ {WF}_{k} \\ Δ TR {Q}_{k}\end{matrix} ] + [ \begin{matrix}0 \\ 1 \\ 1\end{matrix} ] Δ {NHC}_{k} \qquad ( eq . 2 )$$

The term ΔNHCk=NHCk−NHCk−1 corresponds to the difference between the last setpoint of rank k and the penultimate setpoint of rank k−1.

Equation (2) can be used to determine a third equation, or equation (3), expressing the variation of the fuel flow rate ΔWFₖ and the variation of the electrical torque ΔTRQₖ as a function of
the difference ΔNHₖ between the last measurement and the penultimate measurement of the engine speed 5,
the deviation ENHₖ associated with the last measurement of the engine speed 5, and
the sum of all the deviations IENHₖ
   in the form of a third equation, or equation (3):

$$[ \begin{matrix}Δ {WF}_{k} \\ Δ TR {Q}_{k}\end{matrix} ] = - K [ \begin{matrix}Δ {NH}_{k} \\ {ENH}_{k} \\ {IENH}_{k}\end{matrix} ] \qquad ( eq . 3 )$$

in which the term “K” is a gain matrix.

The variation of the fuel flow rate ΔWFₖ and the variation of the electrical torque ΔTRQₖ are obtained, particularly simultaneously, by the product of the gain matrix K and of a vector formed by
the difference ΔNHₖ between the last measurement and the penultimate measurement of the engine speed 5,
the deviation ENHₖ associated with the last measurement of the engine speed 5 and
the sum IENHₖ of all the deviations.

For using a corrector, it is necessary, first, to determine the gain matrix K, which amounts to carrying out “a synthesis of the multi-variable corrector.”

Such a synthesis is of the “quadratic linear state feedback” type (linear quadratic LQ command) and consists of minimizing a criterion or a quantity “J” in which appear the weighting matrices Q, R and S.

These are fixed at the beginning of the calculation as a function of the desired behavior of the engine and, in particular, as a function of the desired absence of lag.

More precisely, it is the selection of the weighting matrices Q, R and S which allows obtaining different adjustments of the corrector and the desired engine behavior, for example the suppression of lag, i.e. minimization of the transfer between the setpoint and the servo error within the meaning of the 2-norm by constraining the error dynamics.

$$J = {\sum }_{k = 0}^{∞} Q \times Δ {NH}_{k}^{2} + [ Δ {WF}_{k} Δ TR {Q}_{k} ] \times R \times [ \begin{matrix}Δ {WF}_{k} \\ Δ TR {Q}_{k}\end{matrix} ] + 2 Δ {NH}_{k} \times S \times [ \begin{matrix}Δ {WF}_{k} \\ Δ TR {Q}_{k}\end{matrix} ]$$

The minimization of the criterion J by the Lagrangian allows working with an analytic expression of the gain matrix K in the form:

$$K = {( R + {B}^{T} PB )}^{- 1} ( {B}^{T} PA + S )$$

where the terms R, B, A and S are known matrices. Only the matrix P remains to be determined according to the unique solution to the discrete algebraic Riccati equation:

$${\tilde{A}}^{T} P \tilde{A} - P - ( {\tilde{A}}^{T} P + S ) {( {\tilde{B}}^{T} P \tilde{B} + R )}^{- 1} ( {\tilde{B}}^{T} P \tilde{A} + {S}^{T} ) + Q = 0$$

with:

$$\tilde{A} = [ \begin{matrix}A & 0 & 0 \\ - 1 & 1 & 0 \\ - 1 & 1 & 1\end{matrix} ] and \tilde{B} = [ \begin{matrix}B \\ 0 \\ 0\end{matrix} ]$$

This last equation allows determining the matrix P, and consequently the gain matrix K.

Knowing the gain matrix K allows, in the control method, determining, particularly simultaneously, the variation of fuel flow rate ΔWFₖ and the variation of electrical torque ΔTRQₖ as a function of the difference ΔNHₖ between the last measurement and the penultimate measurement of the engine speed 5, the deviation ENHₖ associated with the last measurement of the engine speed 5, and the sum IENHₖ of all the deviations, by using the third equation, or equation (3):

$$[ \begin{matrix}Δ {WF}_{k} \\ Δ TRQ\end{matrix} ] = - k [ \begin{matrix}Δ {NH}_{k} \\ {ENH}_{k} \\ {IENH}_{k}\end{matrix} ] \qquad ( eq . 3 )$$

It should be noted that the gain matrix K depends on the operating point of the engine. More precisely, the gain matrix K is determined based on the terms A and B which depend on the operating point of the engine.

This is taken into account in practice by predetermining a set of reference matrices and, depending on the measurement of the engine operating point, calculating the gain matrix by interpolation between two reference matrices.

The set of reference matrices is determined beforehand prior to the implementation of the control method. Each reference matrix is associated with an operating point of the hybrid turbine engine 1 called a reference point.

A reference matrix is associated with an equation of evolution of a tracking vector of a speed command or of an angular speed formed by a variation of the speed or of the angular speed in one instant, from a commanded speed or angular speed difference at an instant, from a commanded speed or angular speed difference at the instant and from an integral of the difference.

The operating point can in particular be deduced from an internal measurement of the engine, for example a measurement of the speed or of the angular speed of the drive shaft or a measurement of an input pressure of the combustion chamber, and of an external measurement of the engine, for example the external pressure. The operating point can therefore be associated with a vector of several measurements.

The measured operating point, more specifically an “operating point” vector, allows determining the gain matrix K to be used at this point by linear interpolation between the reference matrices associated with reference vectors which flank the “operating point” vector.

Accounting for fuel saturation, i.e. the impossibility of increasing a fuel setpoint above a certain maximum, also called “control saturation,” and/or of the torque, i.e. the impossibility of increasing the electrical torque setpoint due to a machine limit or a limit of a hybridization level, can be managed by an “augmentation” of the model.

For example, the state vector comprising
the difference ΔNHk between the last measurement and the penultimate measurement of the engine speed 5,
the deviation ENHₖ associated with the last measurement of the engine speed 5, corresponding in particular to the servo error, and
the sum IENHₖ of all the deviations, corresponding in particular to the integral of the servo error,
   can be completed by a deviation between the control saturation and the command calculated by the trajectory tracking corrector.

Different manners for taking into account a state vector of this type can be considered, particularly by considering it as a perturbation and/or, according to one manner, invoking the mathematical tools described previously.

The fuel flow setpoint 9 and the torque setpoint 11 are calculated by numerical integration according to the following equations:

$$\{ \begin{matrix}{WF}_{k} = Δ {WF}_{k} + {WF}_{k - 1} \\ {TRQ}_{k} = Δ {TRQ}_{k} + {TRQ}_{k - 1}\end{matrix}$$

### Results

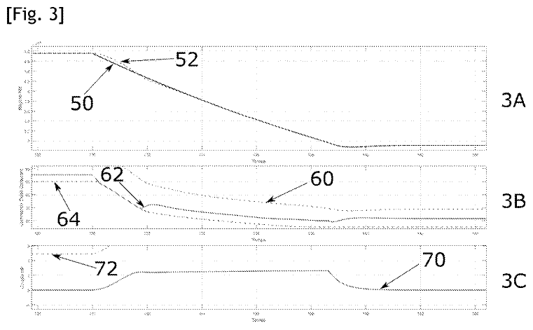

FIGS. 2 and 3 are schematic representations of command tracking respectively in acceleration and in deceleration according to the invention and show the results of numerical simulations of command tracking according to the control method previously presented.

FIG. 2 is more specifically related to an acceleration of the engine speed.

FIG. 2 comprises a first graph 2A on which the axis of the ordinates corresponds to the engine speed, or angular speed, and the axis of the abscissas corresponds to time.

The first graph 2A of FIG. 2 includes:
a setpoint curve 20, corresponding to the engine speed setpoint 7,
a speed curve 22, corresponding to the measurement of the engine speed 5, and
a minimum speed curve 24, corresponding to a minimum engine speed.

Moreover, FIG. 2 comprises a second graph 2B on which the axis of the ordinates corresponds to a fuel flow rate and the axis of the abscissas corresponds to time. The second graph 2B of FIG. 2 includes:
a maximum fuel flow rate curve 30, corresponding to a maximum fuel flow rate not to be exceeded for the current engine speed,
a minimum fuel flow rate curve 34, corresponding to a minimum fuel flow rate below which it is not possible to descend, and
a fuel command curve 32, corresponding to the fuel flow rate command 9.

Moreover, FIG. 2 comprises a third graph 2C on which the axis of the ordinates corresponds to an electrical torque and the axis of the abscissas corresponds to time.

The third graph 2C of FIG. 2 includes:
an electrical torque command curve 40, corresponding to the electrical torque command 11.

The first graph 2A, the second graph 2B and the third graph 2C of FIG. 2 are synchronized, so that at each instant the different graphs give the setpoint, measurement and/or command values corresponding to the operating point of the hybrid turbine engine 1.

Finally, FIG. 3 is more specifically related to a deceleration of the engine speed.

FIG. 3 comprises a first graph 3A in which the axis of the ordinates corresponds to an angular speed and the axis of the abscissas corresponds to time.

The first graph 3A of FIG. 3 includes:
a setpoint curve 50, corresponding to the engine speed setpoint 7, and
a speed curve 52, corresponding to the measurement of the engine speed 5.

Moreover, FIG. 3 comprises a second graph 3B in which the axis of the ordinates corresponds to a fuel flow rate and the axis of the abscissas corresponds to time. The second graph 3B of FIG. 3 includes:
a maximum fuel flow rate curve 60, corresponding to a maximum fuel flow rate not to be exceeded for the current engine speed,
a minimum fuel flow rate curve 64, corresponding to a minimum fuel flow rate below which it is not possible to descend,
a fuel command curve 62, corresponding to the fuel flow rate command 9.

In addition, FIG. 3 comprises a third graph 3C in which the axis of the ordinates corresponds to an electrical torque and the axis of the abscissas corresponds to time.

The third graph 3C of FIG. 3 includes:
an electrical torque command curve 70, corresponding to the electrical torque command 11, and
a maximum electrical torque curve 72, corresponding to a maximum electrical torque not to be exceeded for the current engine speed.

The first graph 3A, the second graph 3B and the third graph 3C of FIG. 3 are synchronized, so that at each instant the different graphs give the setpoint, measurement and/or command values at the operating point of the hybrid turbine engine 1.

The fuel flow rate command 9 and the electrical torque command 11 are generated in real time by the control method previously described.

In FIGS. 2 and 3, the sequences of setpoints, of measurements and of commands contain so many points that the rendering in the figures is assimilable, for each, to a continuous curve.

It is noticed first of all that the fuel flow rate command 9 and the electrical torque command 11 vary independently. In particular, the electrical torque command 11 can be different from zero without the fuel flow rate command 9 being saturated, i.e. congruent with the maximum fuel flow rate curve 60 or the minimum fuel flow rate curve 64.

For example, the fuel flow rate command curve 32 in FIG. 2 is never in saturation while the electrical torque command curve 40 varies and assumes values different from zero.

When this generation of the two commands is simultaneous, it allows exploring a broader range of operating speeds of the hybrid turbine engine 1 than in the prior art and better optimization of operation.

Moreover, the lag error is low in the result illustrated. A lag error corresponds to a temporal offset between the setpoint and the measurement of the output quantity. There is a lag, for example, when the speed or the angular speed measured is delayed relative to the setpoint speed or angular speed 20.

The speed curve 22 is not or is slightly offset temporally relative to the setpoint curve 20, so that the lag is small.

Such a benefit arises in particular from the fact that the control method corresponds to an architecture of the class 2 “state feedback” type, i.e. comprising 2 integrators or two integrated quantities, namely the deviation ENHₖ associated with the last measurement of the engine speed 5, and the sum IENHₖ of all the deviations, for calculating, particularly simultaneously, the fuel flow rate setpoint 9 and the electrical torque setpoint 11.

The fuel flow rate setpoint 9 and the electrical torque setpoint 11 allow tracking the acceleration and/or deceleration trajectory of the engine speed without lag when the tracking loop is activated and applied.

In fact, depending on the flight phase, the setpoint obtained by the computer, as described up to the present, can be used or not. Depending on the flight phase, the need for a low lag error is not always present. That is particularly the case for a “cruise” flight phase where there are few rapid transients and where there would be a tendency to use a more suitable corrector.

Although the class 2 “state feedback” is not always applied, it is however always active, in the sense that it continuously calculates a setpoint. This allows in particular a continuity of the setpoint when switching from one computer to another.

The control method and the control device 3 according to the invention allow responding to the pilot's need while taking into account the capacity of the engine to accelerate or decelerate, and in particular to:
limit the acceleration time of “good” engines having a pumping margin in order to reduce over-feeding of fuel to the combustion chamber, also designated by the term “over-fueling,” and thus limiting an exhaust temperature of the gas (also designated by the term “Exhaust Gas Temperature” or the acronym EGT) during accelerations to increase lifetime; and
limit the asymmetry of thrust between the engines during acceleration in order to reduce the drag of the airplane and the engine yaw effect.

1. A method for controlling a hybrid turbine engine, the method comprising:
determining a sequence of deviations, each deviation being a difference between one measurement of a sequence of measurements of a speed of a drive shaft of the hybrid turbine engine and one setpoint of a sequence of engine speed setpoints;
determining a variation of a fuel flow rate and determining a variation of an electrical torque, wherein the determining the variation of the fuel flow rate and determining the variation of the electrical torque both comprise using a difference between a last measurement of the sequence of measurements and a penultimate measurement of the sequence of measurements, a last deviation of the sequence of deviations, the last deviation being temporally associated with the last measurement, and a sum of the deviations of the sequence of deviations; and
controlling the hybrid turbine engine in order to vary the fuel flow rate according to the determined variation of the fuel flow rate and in order to vary the electrical torque according to the determined variation of the electrical torque.

2. The method according to claim 1, wherein, during the determining the variation of fuel flow rate and the determining the variation of electrical torque, both comprise determining a product of a gain matrix and a vector, the vector being formed from the difference between the last measurement of the sequence of measurements and the penultimate measurement of the sequence of measurements, the last deviation of the sequence of deviations and the sum of the deviations.

3. The method according to claim 2, further comprising determining the gain matrix by interpolation between two reference matrices of a set of reference matrices so as to take into account an operating point of the hybrid turbine engine associated with the last measurement.

4. A control device for a hybrid turbine engine, the control device comprising:
an input configured to receive a sequence of measurements of the engine speed of the hybrid turbine engine;
a memory configured to record the sequence of measurements and a sequence of speed setpoints;
a computer configured to determine a sequence of deviations, each deviation being a difference between one measurement of a sequence of measurements of the engine speed of the hybrid turbine engine, and one setpoint of a sequence of engine speed setpoints, the computer being configured to determine a variation of fuel flow rate and a variation of electrical torque, the computer being configured, in order to determine the variation of fuel flow rate and to determine the variation of electrical torque, to use a difference between a last measurement of the sequence of measurements and a penultimate measurement of the sequence of measurements, a last deviation of the sequence of deviations, the last deviation being temporally associated with the last measurement, and a sum of the deviations of the sequence of deviations; and
an output configured to provide a command to the hybrid turbine engine.

5. A hybrid turbine engine comprising the control device according to claim 4.

6. An aircraft comprising the hybrid turbine engine according to claim 5.

7. The method according to claim 1, wherein the determining the variation of the fuel flow rate and the determining the variation of the electrical torque are simultaneous.

8. The control device according to claim 4, wherein the computer is configured to simultaneously determine the variation of fuel flow rate and the variation of electrical torque.
